(19) United States
(12) Patent Application Publication
(10) Pub. No.: US 2025/0310286 A1
(43) Pub. Date: Oct. 2, 2025

(54) ENHANCE CHAT INTERACTION THROUGH 2-WAY UI COMMUNICATION

(71) Applicant: Microsoft Technology Licensing, LLC, Redmond, WA (US)

(72) Inventors: Waldemar MASTYKARZ, Alphen aan den Rijn (NL); Gavin Douglas BARRON, Bothell, WA (US); Garry James TRINDER, Goole (GB); Ayca BAS, Dubai (AE)

(21) Appl. No.: 18/622,789

(22) Filed: Mar. 29, 2024

(51) Int. Cl. H04L 51/04; G06F 3/01

(52) U.S. Cl. CPC H04L 51/04; G06F 3/013

(57) ABSTRACT

A computerized method enhances chat interaction through 2-way user interface (UI) communication. Data associated with an element, selected by a user from a UI of a web application, is received in a chat box. A query corresponding to the selected element is received in the chat box. A request is sent to a language processor for a list of application programming interfaces (APIs) relevant to the query and the data. For each API, the query and the data are sent to the API, and an answer including a data text and a data object is received from the API. A request including the data texts for a cohesive answer is sent to the language processor that returns the cohesive answer. If the web application can render the data object, the data object and the cohesive answer are presented on the UI of the web application.

### BACKGROUND

Many organizations use chat applications that perform various tasks such as offering employees automated bots, answering common questions, assisting with common problems, and connecting with human agents. A chat application interacting with a chat bot typically involves a user communicating with the chat bot through text-based messages exchanged within the application's interface. However, using chat applications requires users to communicate using plain-text and having to express their intent in lengthy prose.

For example, a user of the chat application may have to write paragraphs of text, rewrite and/or refine it until the chat application understands the user's intent. Based at least on receiving the user's message, the chat bot processes the input using natural language understanding (NLU) and natural language processing (NLP) techniques to interpret the user's intent and extract relevant information. Based on the user's input and described intent, the chat bot formulates a response using pre-defined conversation flows, logic, or algorithms. The response may involve providing information, answering questions, executing tasks, or initiating further interaction. The chat application displays the chat bot's response in the chat interface, presenting it as a text message that appears within the conversation thread. The user can read the chat bot's reply and continue the conversation by sending additional messages.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for enhancing chat interaction through 2-way user interface (UI) communication is described. Data associated with a selected element is received in a chat box associated with a chat application, wherein the selected element is selected by a user from a user interface of a web application. A query corresponding to the selected element is received from the user in the chat box. A request is sent to a language processor for a list of application programming interfaces (APIs) that are relevant to the query and the data associated with the selected element. The list of relevant APIs is received from the language processor. For each API on the list of relevant APIs: the query and the data associated with the selected element are sent to the API, and an answer to the query including a data text and a data object is received from the API. A request for a cohesive answer for the user based on the data texts received from the APIs is sent to the language processor. The cohesive answer is received from the language processor. A determination is made whether the web application is capable of rendering the data object. Based at least on determining that the web application is capable of rendering the data object, the data object and the cohesive answer are presented on the user interface of the web application.

### BRIEF DESCRIPTION OF THE DRAWINGS

The present description will be better understood from the following detailed description read considering the accompanying drawings, wherein:

FIGS. 1A-1B illustrate a block diagram of an example system for enhancing chat interaction through 2-way UI communication;

FIGS. 2A-2B are block diagrams illustrating transformation of a user interface in some examples of the disclosure;

FIGS. 3A-3D illustrate a sequence diagram for enhancing chat interaction through 2-way UI communication;

FIG. 4 is a flowchart illustrating an example method for enhancing chat interaction through 2-way UI communication;

FIG. 5 illustrates an example computing apparatus as a functional block diagram.

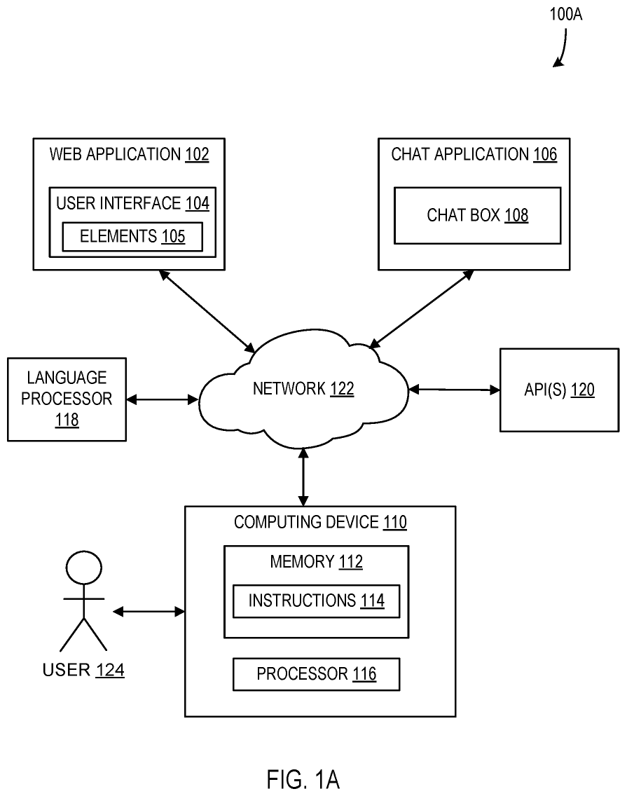

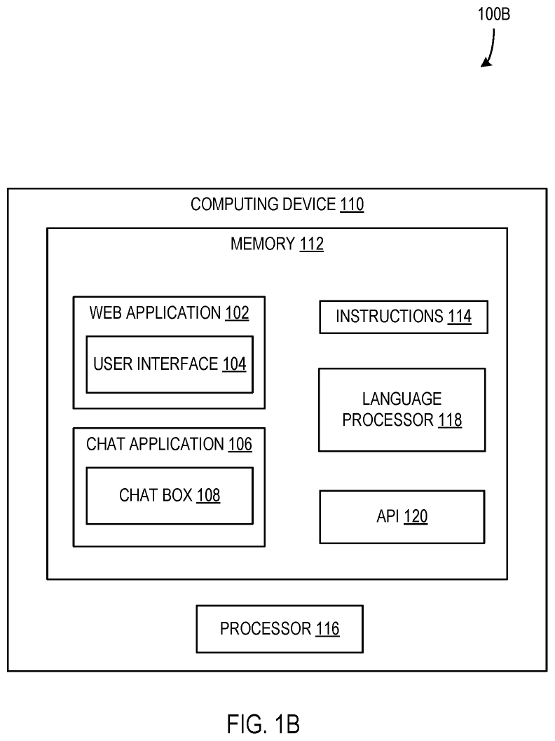

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods for enhancing chat interaction through 2-way user interface (UI) communication between a web application and a chat application. A selection of an element presented in a user interface of the web application is received from a user. Data associated with the selected element is received in a chat box associated with a chat application. The data associated with the selected element acts as context for a query that may be received from the user in the chat box. A request is sent to a language processor for a list of application programming interfaces (APIs) that are relevant to the query and the data associated with the selected element. The list of relevant APIs is received from the language processor. For each API on the list of relevant APIs: the query and the data associated with the selected element are sent to the API, and an answer to the query including a data text and a data object is received from the API. A request for a cohesive answer for the user based on the data texts received from the APIs is sent to the language processor. The cohesive answer is received from the language processor. A determination is made whether the web application can render the data object. Based at least on determining that the web application can render the data object, the data object and the cohesive answer are presented on the user interface of the web application.

The disclosure operates in an unconventional manner at least by enhancing chat interaction through 2-way user interface (UI) communication between a web application and a chat application. In a conventional system, user interaction with the elements on a user interface of a web application is lost when the user goes to the chat application with an intent for querying for information related to an element on the user interface of the web application. Aspects of the disclosure capture user interaction with elements on the user interface and provide data associated with the elements (e.g., selected or interacted with by the user) to the chat box of the chat application. In some examples, the data associated with the elements is provided to the chat box of the chat application in transparent manner and without any additional effort by the user (e.g., without needing the user to provide lengthy prose for context associated with the element to the chat box). Thus, examples of the disclosure reduce processing resource requirements and enhance user experience as processing resources do not need to wait for entry of lengthy input from the user and the user does not need to provide lengthy prose to convey intent of the user. As another example, the disclosure operates in an unconventional manner at least by presenting the data object and the cohesive answer on the user interface of the web application. The user interface of the web application is not read-only and the elements on the user interface may be overlayed or replaced with the data object and/or the cohesive answer obtained by the chat box of the chat application. Existing chat applications do not make any use of the rich UI surface to get the user's intent or context that could have been provided with a selection made on the UI surface. Further, the existing chat applications link to organizational information using application programming interfaces (APIs) to retrieve information that is relevant to the chat conversation in a structured way. However, as this structured information is passed to the chat application, most of the information details are lost as the reply is converted into a human-readable response.

Examples of the disclosure simplify expressing user intent in chat-based communication. Further, examples of the disclosure enable users to advantageously express their intent to a chat application in an efficient manner by enabling the user to interact with and/or select elements on the screen that correspond to a query the user intends to make, which makes it easier and faster to provide context to the chat application going across language boundaries and users' abilities to express themselves in writing when submitting a query.

Some examples described herein showcase how the rich UI could work together with chat interfaces. For example, by selecting one or more visual elements on the screen, a user can set the context of their conversation with a selection of one or more elements displayed. With the context in place, the user can express intent with a single sentence or a small query that would have been cryptic and incomprehensible otherwise but is now fully understandable because of the context provided by the selection of the one or more elements. Once a chat agent (e.g., bot or a human agent) finds the relevant information, the chat application returns a human-readable summary that is visualized on the page along with structured information retrieved from APIs with rich formatting to help the user quickly and easily understand and process the information. Thus, the rich UI rendering capabilities of the user interface of the web application may be used to present information in visual ways to increase its comprehension.

FIG. 1A is a block diagram illustrating a system 100A for enhancing chat interaction through 2-way UI communication. A user 124 may access a web application 102 on a computing device 110. In some examples, a selection of an element from a plurality of elements 105 presented in a user interface 104 of the web application 102 is received from the user 124. For example, the user 124 may select the element from the plurality of elements 105 presented on the user interface via a mouse click, a touch input, a gesture input, an eye gaze, or a verbal command. In another example, the plurality of elements 105 that are presented on the screen are automatically selected by virtue of the plurality of elements 105 being displayed to the user 124. In this example, whatever elements in the plurality of elements 105 are currently being displayed are considered selected for context purposes.

Data associated with the selected element from the plurality of elements 105 is received in a chat box 108 associated with a chat application 106. The data associated with the selected element from the plurality of elements 105 acts as context data and may not be shown in the chat box 108. In some examples, an interaction of the user 124 with the plurality of elements 105 is captured by instructions 114 running in a background and passed on as data associated with the interaction to the chat box 108. These instructions 114 are stored in memory 112 of a computing device 110 and executed by a processor 116. The instructions have permissions to capture the user interaction on the user interface 104 of the web application 102. Data associated with the selected element from the plurality of elements 105 may include data associated with selection of more than one of the plurality of elements 105 or a sequence of user interaction with the plurality of elements 105.

A query is received from the user 124 in the chat box 108 with the intent of the user 124 finding out information associated with the selected element from the plurality of elements 105. As the user interaction on the user interface 104 of the web application 102 is captured as context data, the query entered by the user 124 in the chat box 108 may be a short query. For example, a user may select a calendar event (e.g., a selected element) on a particular day of a calendar comprising a plurality of events (e.g., the plurality of elements 105) on the user interface 104 of a calendar application as the web application 102. In this example, the user 124 may select the calendar event and may want to know “how to prepare for it?” In a conventional chat box, a user must enter a lengthy query to describe the user's intent. However, in examples of the disclosure, the user 124 may only enter “how to prepare for it?” in the chat box 108 because the context with respect to the query of the user 124 is already captured based on the selection of the element (i.e., the calendar event) on the user interface 104.

Based at least on entry of the query in the chat box 108, a request is sent to a language processor 118 for a list of relevant application programming interfaces (APIs) from a plurality of APIs 120 that are relevant to the query and the data associated with the selected element from the plurality of elements 105. APIs from the list of relevant APIs from the plurality of APIs 120 may be data sources that may be relevant to the query and the data associated with the selected element 105 from the plurality of elements 105. For example, a project database may be a relevant API when the selected calendar event is related to a project. Similarly, both the project database and a purchase order database may be the relevant APIs when the selected calendar event is related to a purchase order for a project. In one example, the list of relevant APIs from the plurality of APIs 120 is received from the language processor 118.

For each of the relevant APIs from the plurality APIs 120, the query and the data associated with the selected element from the plurality of elements 105 are sent to a relevant API. The relevant API thereafter provides, to the chat box 108, an answer to the query. In one example, the answer to the query includes a data text and a data object. A time of data object depends on one or more of the APIs connected to the web application 102. However, the relevant APIs may not provide the data text and the data object as an answer that is cohesive for the user 124. In one example, the relevant APIs interact with the web application 102 using structured data and the language processor 118 converts the structured data into a cohesive answer. As such, in some examples, the chat box 108 sends a request, to the language processor 118, for a cohesive answer for the user 124 based on the data texts received from each of the relevant APIs from the plurality APIs 120. In some examples, all of the data texts and the data objects are sent to the language processor 118 at the same time because different data texts and data objects may be received from the relevant APIs. As such, the language processor 118 is provided with all of the relevant information (e.g., all of the data texts and data objects received from the relevant APIs) in order to provide the most comprehensive cohesive answer.

In one example, a determination is made as to whether the web application 102 can render the data object. If it is determined that the web application 102 cannot render the data object (e.g., the web application does not support the type of rendering needed), then the data object is not rendered. In contrast, based at least on determining that the web application can render the data object, the data object (and the cohesive answer) are presented on the user interface 104 of the web application 102. For example, the user interface 104 may include a visual portion and a text box portion such that the data object is presented in the visual portion and the cohesive answer is presented to the user 124 in the text box portion. The rendered data object is a visual representation corresponding to the cohesive answer such that it is easy for the user 124 to understand the data object just by going through the cohesive answer. In some examples, the rendered data object is a document card, a chart, an image, or a video.

In some examples, the chat application 106 runs in background as the user 124 interacts with one or more of the plurality of elements 105 on the UI 104. For example, the chat application 106 may include the instructions 114 to capture the context data of the interaction of the user 124 with the plurality of elements 105 on the UI 104, and the chat box 108 associated with the chat application 106 may be invoked in response to a selection of an element from the plurality of elements 105 presented in the UI 104 of the web application 102.

Further, in some examples, the system 100 includes one or more computing devices 110 (e.g., the computing apparatus of FIG. 6) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the user 124 may interact with one or more of the plurality of elements 105 on the user interface 104 of the web application 102 from the computing device 110 (e.g., a first computing device). The web application 102 may be hosted on a second computing device and the chat application may be hosted on a third computing device. Similarly, the language processor 118 may be provided on a fourth computing device and the plurality of APIs 120 may be provided on a fifth computing device. In this example, the first through the fifth computing devices are configured to communicate with each other via network connections through network 122. In other examples, other organizations of computing devices are used to implement system 100 without departing from the description.

For example, FIG. 1B illustrates a block diagram of an example system 100B in which the web application 102 (providing the user interface 104), the chat application 106 (providing the chat box 108), the instructions 114, the language processor 118, and the plurality of APIs 120 are stored in the memory 112 and execute on the computing device 110 (e.g., the computing apparatus of FIG. 6) by processor 116. The functionality of the different entities in FIG. 1B is similar to the functionality of their corresponding entities in FIG. 1A.

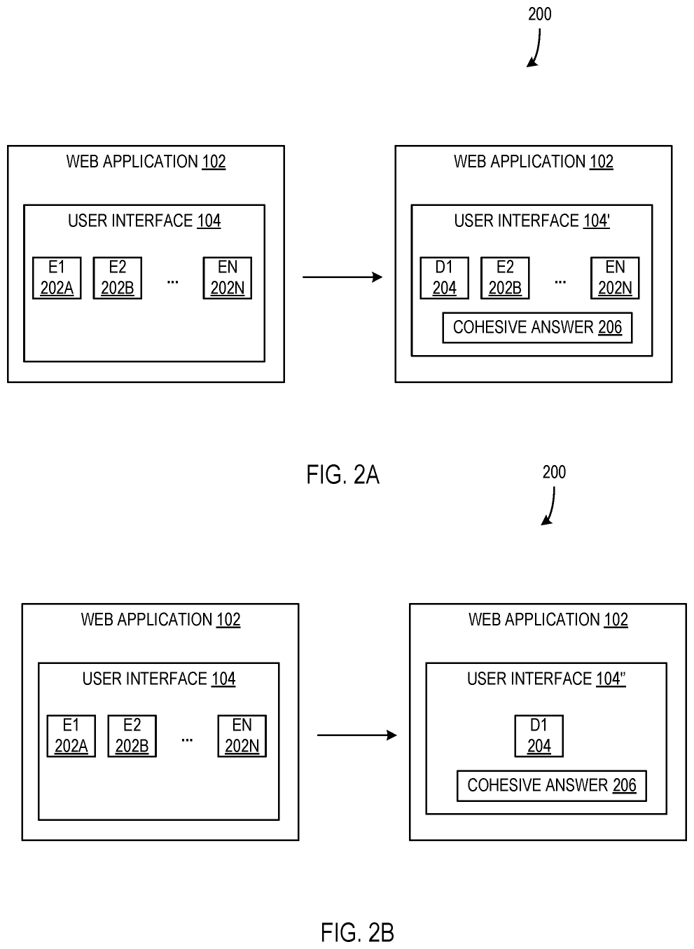

FIGS. 2A and 2B are block diagrams of a system 200 illustrating transformation of a user interface (e.g., the user interface 104). In some examples, after the user 124 selects one or more of the plurality of elements 105 (e.g., elements E1 202A, E2 202B, . . . EN 202N) on the user interface 104 of the web application 102 for context and thereafter submits a query, the user interface 104 (as shown on the left side of FIG. 2A) is transformed into the transformed user interface 104′ (as shown on the right side of FIG. 2A). The transformed user interface 104′ includes the data object D1 204, elements E2 202B . . . EN 202N, and the cohesive answer 206 in response to the query of the user 124. In this example, the data object D1 204 replaces the element E1 202A and the cohesive answer 206 is shown in a text portion of the transformed user interface 104′. In some examples, the data object D1 204 replaces one or more other elements (e.g., elements E2 202B . . . EN 202N) instead of the element E1 202A or is added to (e.g., without replacing an existing element) the user interface 104′ so that the user 124 may continue to query some other information related to the element E1 202A.

In some examples, as shown in FIG. 2B, after the user 124 selects one or more of the plurality of elements 105 (e.g., elements E1 202A, E2 202B, . . . EN 202N) on the user interface 104 of the web application 102 for context and thereafter submits a query, the user interface 104 (as shown on the left side of FIG. 2B) is transformed into the transformed user interface 104″ (as shown on the right side of FIG. 2B). The transformed user interface 104″ includes the data object D1 204 and the cohesive answer 206, but does not include the elements E1 202A, E2 202B . . . EN 202N in response to the query of the user 124.

In some examples, more than one data objects (such as data object D1 204) may be shown on the transformed user interface 104 replacing one, a plurality, or all of the elements E1 202A, E2 202B, . . . EN 202N. In some examples, the data objects (such as data object D1 204) and the cohesive answer 206 may be overlayed on the user interface 104″ of the web application 102. Other examples of presenting the data objects (such as data object D1 204), elements (e.g., elements E1 202A, E2 202B, . . . EN 202N), and the cohesive answer 206 on the user interface 104″ of the web application 102 are within the scope of aspects of the disclosure.

In some examples, the user 124 may interact with the data object (such as the data object D1 204) just like the elements (e.g., elements E1 202A, E2 202B, . . . EN 202N). That is, a user 124 may select the data object D1 204 for context with respect to a second query. In another example, the data object D1 204 is automatically selected for context when a user submits the second query and the user need not actively select the data object D1 204. For example, given that the data object D1 204 is presented to the user 124 in response to the first query submitted by the user 124, the system 200, and more specifically, the user interface 104′/web application 102 predicts that a second query submitted by the user 124 corresponds to the data object D1 204, and thus the user interface 104′/web application 102 automatically selects the data object D1 204 (e.g., without intervention by the user 124). In such examples, the second query corresponding to the data object D1 204 is received from the user 124 (e.g., via the chat box 108 of the chat application 106); and thereafter, a request for a list of APIs that are relevant to the second query and data associated with the data object D1 204 is sent to the language processor 118. The list of relevant APIs is received from the language processor 118 and for each API on the list of relevant APIs, the second query and the data associated with the data object D1 204 are sent to the API, and an answer to the second query including a second data text and a second data object is received from the API. A request for a second cohesive answer for the user 124 based on the second data texts received from the relevant APIs is sent to the language processor 118. The second cohesive answer is received from the language processor 118 and a determination is made whether the web application 102 is capable of rendering the second data object. Based at least on determining that the web application 102 is capable of rendering the second data object, the second data object and the second cohesive answer are presented on the user interface 104′ of the web application 102.

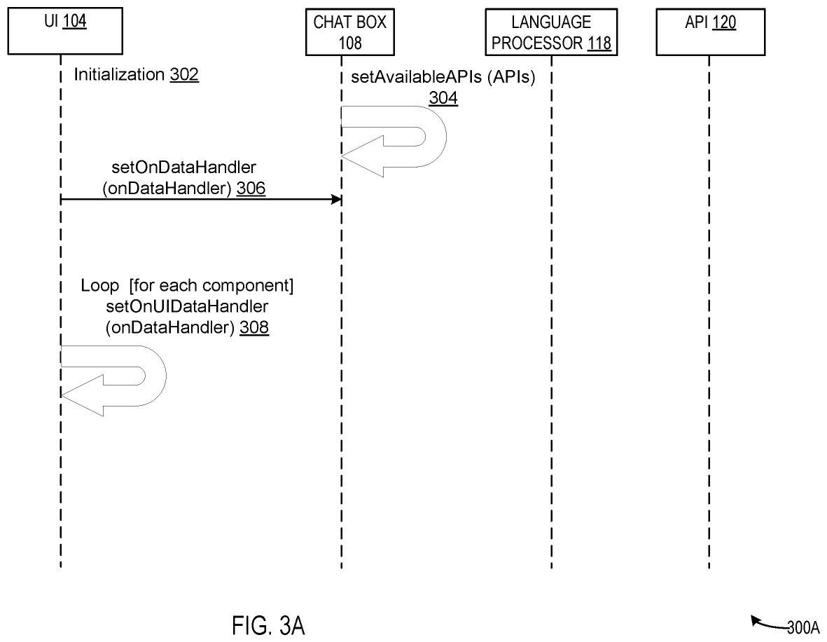

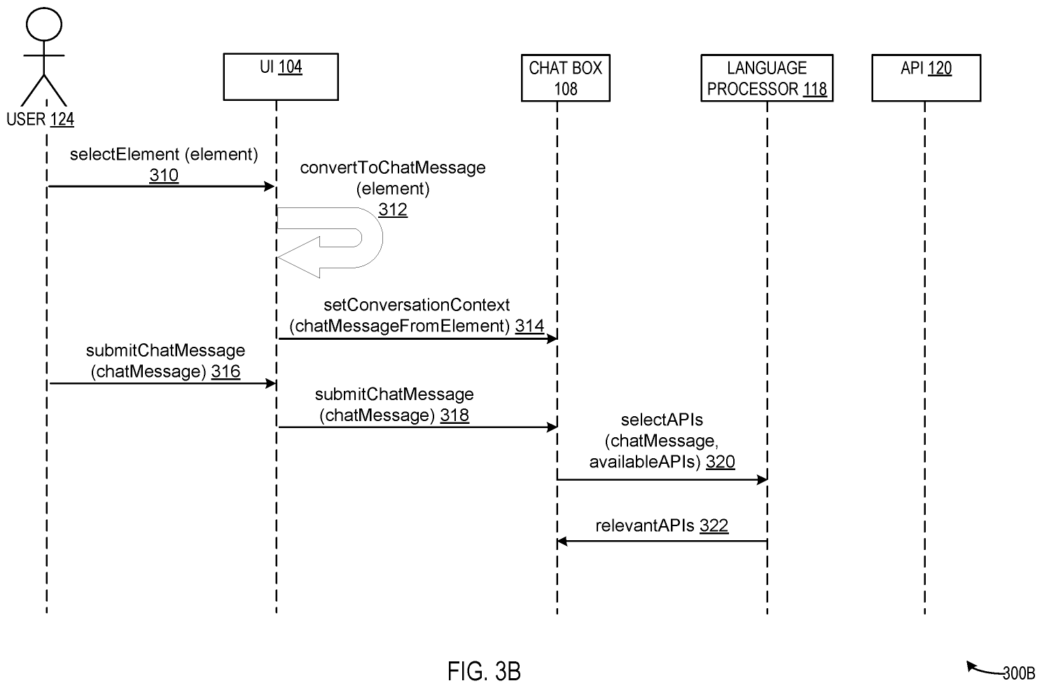

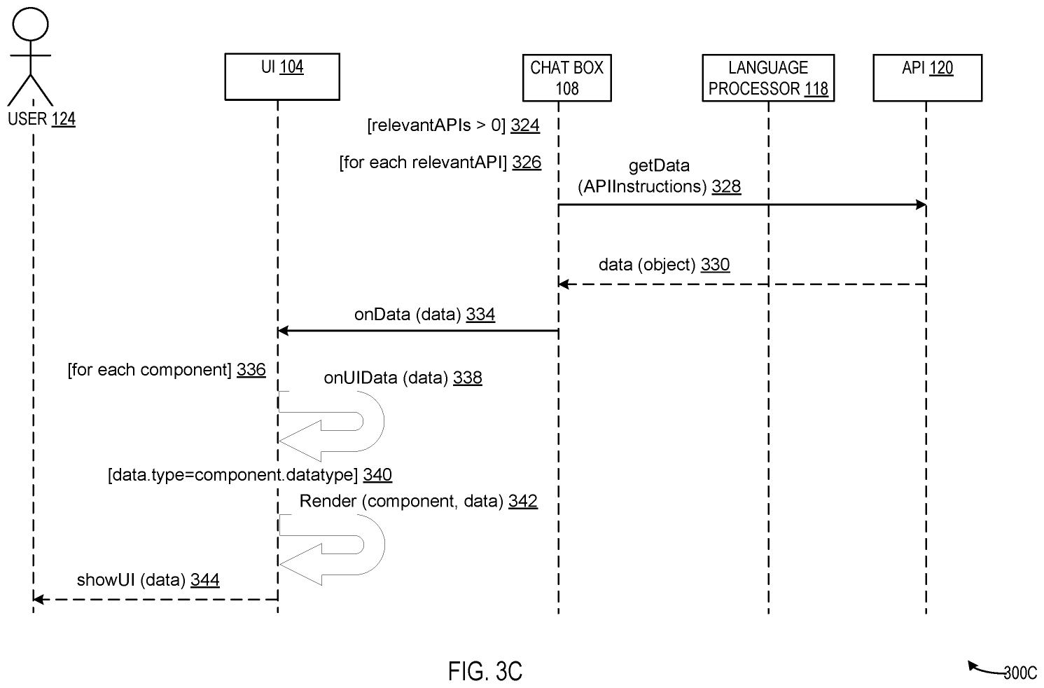

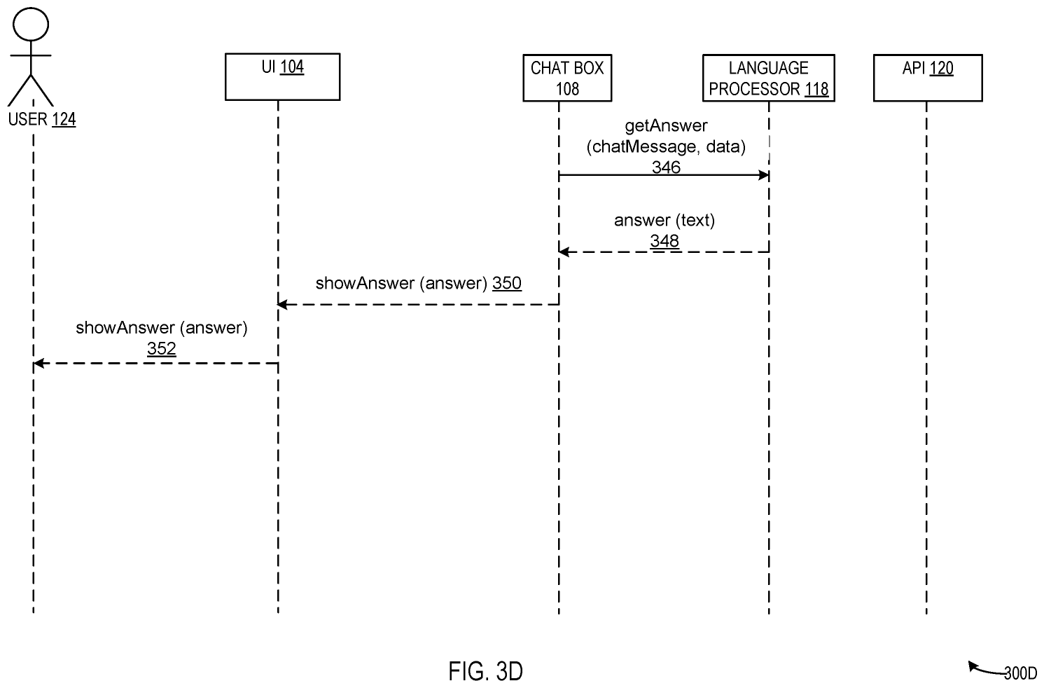

FIGS. 3A-3D illustrate a sequence diagram 300A-300D for enhancing chat interaction through 2-way UI communication based on interaction between different entities shown in FIGS. 1A-1B. In the sequence diagram 300A illustrated in FIG. 3A, as the user 124 accesses the UI 104 of the web application 102, initialization of the plurality of elements 105 available on the UI 104 is performed at 302. In some examples, data associated with the plurality of elements 105 is provided to the chat box 108 as the user 124 accesses the UI 104 e.g., even before the user 124 starts interacting with the plurality of elements 105 on the UI 104. The chat box 108 determines the available APIs (e.g., the plurality of APIs 120) for the plurality of elements 105 at 304. Thus, the chat box can pre-load the available APIs so that it knows what data sources need to be accessed for information corresponding to the plurality of elements 105 on the UI 104. For all the plurality of elements 105 on the UI 104, setOnDataHandler (onDataHandler) provides information about the plurality of elements 105 to the chat box 108 at 306 and loops on the UI 104 for each component to set the events (e.g., a mouse click, a touch input, a gesture input, an eye gaze, or a verbal command) that would invoke the setOnUIDataHandler (onDataHandler) at 308. The initialization 302 (including the operations 304, 306, and 308) may be performed only once in some examples as the user 124 accesses the UI 104 or when the UI 104 is updated.

Continuing now with sequence diagram 300B illustrated in FIG. 3B, as the user 124 selects an element from the plurality of elements 105, selectElement (element) is provided to the UI 104 at 310. As explained above, the user 124 selects one or more of the plurality of elements 105 to indicate the context in which a query the user 124 intends to submit. The UI 104 converts by convertToChatMessage (element) to extract data about the selected element from the plurality of elements 105 at 312. The UI 104 sends chatMessageFromElement to setConversationContext at 314. In some examples, the user 124 may submit the chatMessage at 316 to the UI 104 (e.g., if the chat box is invoked within the execution context of the web application 102) and the UI 104 submits the chatMessage to the chat box 108 at 318. In some other examples, the user 124 directly submits the chatMessage to the chat box 108 (e.g., if the chat box is invoked outside the execution context of the web application 102). At 320, the chat box 108 requests a list of available/relevant APIs (for the selected element and the chatMessage) from the language processor 118. The language processor returns the list of relevant APIs along with the API instructions to the chat box 108 at 322. In this way, when the chat box 108 invokes the language processor 118 to discover relevant APIs to call, the chat box 108 gets back the list of relevant APIs along with instructions on how to call them. In some examples, the relevant APIs work with structured data and require specific arguments to be called. The language processor 118 can infer this information from the chat message and return it to the chat box 108.

Continuing now with the sequence diagram 300C illustrated in FIG. 3C, a count of relevant APIs from the plurality of APIs 120 is determined to be greater than zero at 324. For each relevant API, loop 326 is performed. The loop 326 includes the operations 328-344. At 328, the chat box 108 sends APIInstructions and the extracted data about the selected element to the relevant API from the plurality of APIs 120. The relevant API from the plurality of APIs 120 returns the data object at 330 to the chat box 108. In some examples, the returned data object at 330 includes the data text. In other examples, data text is sent separately from the data object. At 334, the chat box 108 sends the data object to the UI 104.

With continued reference to the sequence diagram 300C, for each component on the UI 104, a loop 336 is performed. The loop 336 includes the operations 338-344. At 338, the UI 104 extracts a data type of the data object and matches the extracted data type with the component's data type (i.e., the data types of the plurality of elements 105 on the UI 104) at 340k and/or data types of components capable of being rendered in the UI 104. If the extracted data type is determined to match the component data type at 340 and/or data types of components capable of being rendered in the UI 104, the data object is rendered at 342 on the UI 104 for presenting to the user 124 at 344.

Continuing now with the sequence diagram 300D illustrated in FIG. 3D, the chat box 108 sends the chatMessage and the data texts to the language processor 118 at 346 to get a cohesive answer at 348. The chat box 108 provides the cohesive answer to the UI 104 at 350 for presenting the cohesive answer to the user 124 at 352 (e.g., at a same time the data object is rendered on the UI 104).

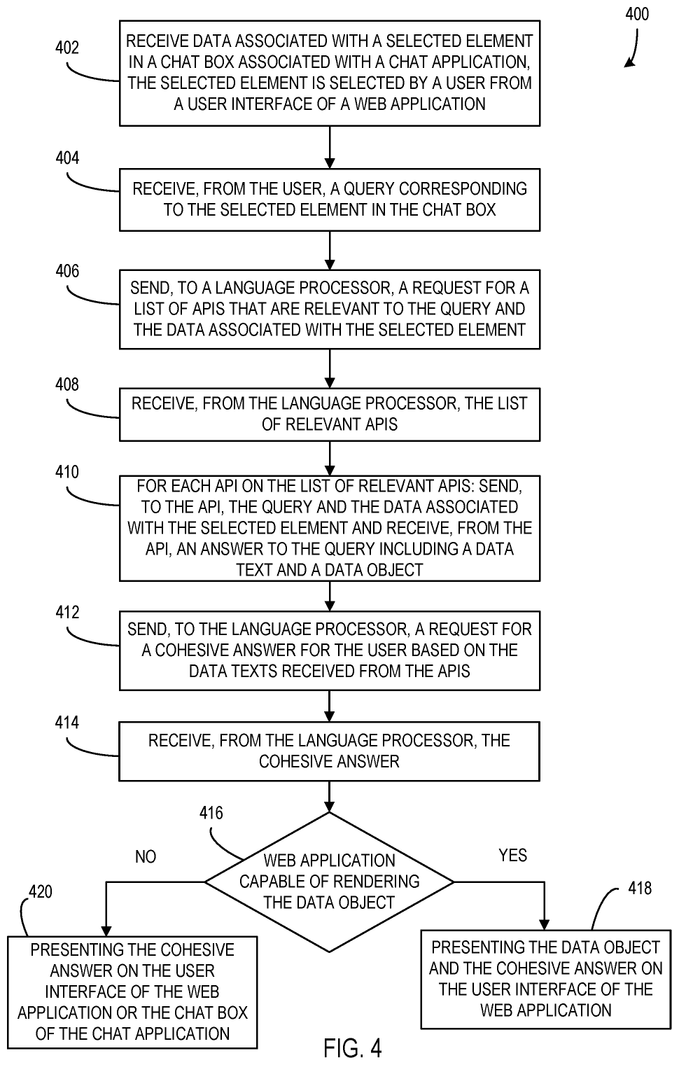

FIG. 4 is a flowchart illustrating an example method 400 for enhancing chat interaction through 2-way UI communication. In some examples, the method 400 is executed or otherwise performed in a system such as systems 100A and 100B of FIGS. 1A and 1B, respectively.

As explained above, to enhance user experience and reduce processing resource requirements, the examples described herein enable the user 124 to advantageously express their intent to the chat application 106 in an efficient manner by enabling the user 124 to interact with and/or select one or more of the plurality of elements 105 on a screen that correspond to a query the user 124 intends to make. This makes it easier and faster to provide context to the chat application 106 going across language boundaries and users' abilities to express themselves in writing when submitting a query. With the context in place, the user 124 can express intent with a single sentence or a small query that would have been cryptic and incomprehensible otherwise but is now fully understandable because of the context provided by the selected one or more of the plurality of elements 105. Thus, with the selected one or more of the plurality of elements 105, at 402, data associated with the selected one or more of the plurality of elements 105 is received in the chat box 108 associated with the chat application 106 in transparent manner and without any additional effort by the user 124 (e.g., without needing the user 124 to provide lengthy prose for context associated with the selected one or more of the plurality of elements 105). In one example, the selected one or more of the plurality of elements 105 is selected by the user 124 from the user interface 104 of the web application 102. In one example, the user 124 selects the selected one or more of the plurality of elements 105 presented on the user interface 104 via a mouse click, a touch input, a gesture input, an eye gaze, or a verbal command At 404, a query corresponding to the selected one or more of the plurality of elements 105 is received from the user 124 in the chat box 108. At 406, a request is sent to the language processor 118 for a list of APIs from the plurality of APIs 120 that are relevant to the query and the data associated with the selected one or more of the plurality of elements 105. At 408, the list of relevant APIs is received from the language processor 118. At 410, for each relevant API on the list of relevant APIs: the query and the data associated with the selected one or more of the plurality of elements 105 are sent to the relevant API, and an answer to the query including a data text and a data object is received from the relevant API. At 412, a request for a cohesive answer for the user 124 based on the data texts received from the relevant APIs is sent to the language processor 118. At 414, the cohesive answer is received from the language processor 118. At 416, a determination is made whether the web application 102 is capable of rendering the data object on the user interface 104. In some examples, based at least on determining that the web application 102 is capable of rendering the data object, the data object and the cohesive answer are presented on the user interface 104 of the web application 102 at 418. In some other examples, based at least on determining that the web application 102 is not capable of rendering the data object, only the cohesive answer is presented on the user interface 104 of the web application 102 or the chat box 108 of the chat application 106 at 420.

### ADDITIONAL EXAMPLES

In some examples, 2-way communication is used between rich UI components (e.g., the plurality of elements 105 in the UI 104 of the web application 102) and a chat box (e.g., the chat box 108 of the chat application 106). Each component can express its selected object as value for use in the chat i.e., the data associated with a selected element from the plurality of elements 105 is passed on as value to the chat box 108. When the chat agent associated with the chat box 108 retrieves the relevant information, it notifies components on the UI 104 of new data (e.g., data object and data text) being available to render. If there are components of the web application 102 that are capable of rendering this information (i.e., the data object), they do so. As components on the UI 104 are predefined by the developer, the developer and designer can optimize the user experience as well as provide the users with structure and properly manage users' expectations, which a fully dynamically rendered dashboard cannot do, because the data and its presentation on the dashboard would change each time.

In some examples, user 124 does not need to enter query in the chat box 108 corresponding to the selected element 105 on the UI 104 and the data object and the cohesive answer are presented transparently (i.e., without any input from the user 124 in the chat box 108) to the user 124 via the UI 104. This is so because the chat box 108 learns from earlier queries entered by the user 124 corresponding to interactions with similar elements from the plurality of elements 105 on the UI 104. Learning from historic queries may be implemented using artificial intelligence and machine learning techniques.

In such examples, the user 124 selects an element from the plurality of elements 105 on the UI 104. Data corresponding to the selected element is sent to the chat box 108. As the chat box 108 already knows the query that is likely to be entered by the user 124 (determined automatically using machine learning based on historic queries entered by the user 124 for similar selections of elements), a request including the data corresponding to the selected element and the likely query are sent to the language processor 118 for a cohesive answer and data object corresponding to the selected element and the likely query. The chat box 108 receives the cohesive answer and data object from the language processor 118 for the list of APIs 120 that are relevant to the selected element and the likely/predicted query. In this example, the language processor 118 gets the answers from the relevant APIs 120 and provides the cohesive answer and data object to the chat box 108. This cohesive answer and the data object are transparently provided by the language processor 118 to the UI 104 that presents the cohesive answer and the data object on the UI 104. In this example, the user advantageously does not need to change focus from the UI 104 of the web application 102 (i.e., the user does not need to provide any input or query in the chat box) and information related to user intent based on interaction with the elements 105 is presented right within the UI 104 of the web application 102.

In some other examples using the artificial intelligence and machine learning techniques as discussed above, as the chat box 108 already knows the query that is likely to be entered by the user 124 (determined automatically using machine learning based on historic queries entered by the user 124 for similar selections of elements), a selection of an element by the user 124 causes the chat box 108 to be automatically filled with a predicted query. In this example, the chat box 108 learns from earlier queries entered by the user 124 corresponding to interactions with similar elements from the plurality of elements 105 on the UI 104. In this example, the user 124 confirms/verifies that the query entered (e.g., it is displayed to the user) inferred the correct intent of the user 124. Thus, a user may confirm the query is correct, request an additional query, or alter the predicted query by editing the query in the chat box 108. Thereafter, the examples of disclosure proceed from operation 406 in FIG. 4.

In some examples, the functionality of the chat application 106 is embedded within the web application 102. In some other examples, the functionality of the chat application 106 is not integrated within the web application 102.

In some examples, the API 120 provides a universal resource locator (URL) to a data object (e.g., an image) and the UI 104 may take the URL and show it as an image. In some examples, if more than one data objects are received by the chat box 108, the chat box 108 may determine to send to the UI 104 only the most relevant of the data objects for presentation on the UI 104. The most relevant data object may be determined based on reputation and/or ranking of the APIs 120 e.g., data objects from trusted APIs 120 are ranked higher than the data objects from untrusted APIs 120. Other ways of determining relevance of the data objects is within scope of this disclosure.

In an example, if the user 124 accesses a page the provides a list of movies and wants to know more about a movie (e.g., by selecting its UI element on the page corresponding to the movie and entering query in the chat box 108). In this example, a movie poster with requested information is provided to the user 124 on the page itself in the UI 104 as described in the examples of the disclosure.

In another example, the user 124 accesses organizations intranet page describing various documents. The user 124 clicks on a policy document that may not be accessible from the page being displayed to the user 123 on the UI 104. The user 124 asks a query saying “share this” and this query and data about the selected policy document is sent via the chat application 106 to a support personnel (e.g., the data source in this example) who provides the requested policy document to the chat application 106. The chat application provides a document card of the policy document for presentation to the user 124 on a portion of the page itself.

In another example, a user 124 travelling in a car accesses a navigation application on a screen and selects a location. The user 124 may provide a query e.g., a verbal query saying, “how far is this?” Because the context is already there from user selection of the location, the user may be presented with information related to the query and the selected location on the screen or via verbal means. For example, the user may be presented with a cohesive answer as “Seattle is 100 miles away and it will take an hour to reach” (e.g., if the user 124 selected a location corresponding to Seattle). If the user, additionally or alternatively, asks query saying “places to visit here”, the user 124 may be presented with an image of “Space Needle” on a portion of the screen and a cohesive answer about the “Space Needle” by verbal means.

In a further example, while aspects of the disclosure enable the user 124 to submit a query and receive answers to the query utilizing a context of a selected element, the user 124 may also submit a query corresponding to a previously selected element. That is, examples described herein enable the user 124 to “back up” and revert back to a previous screen or a previous selected element. In one example, each selected element and the corresponding context is stored in a cache enabling the user 124 to submit a query which is automatically applied against previously selected elements. In another example, elements being displayed are shown in “layers” wherein after each selection, another layer on the user interface 104 is created. In this example, the user 124 can switch between “layers” and the user 124 may also submit a query corresponding to a previously selected element in one of the “layers” or submit a query corresponding to an element that was previously displayed (in the layer being selected) and not yet selected until now. As such, the user 124 is capable of moving forward or backward through the layers of selected elements and presentation of elements (whether previously selected or not) on the user interface 104 and submit a query accordingly.

### Exemplary Operating Environment

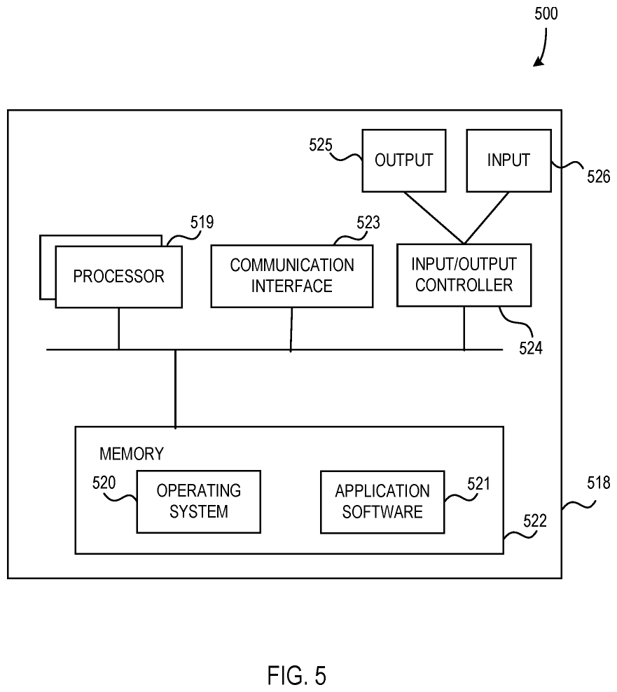

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, enhancing chat interaction through 2-way UI communication as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a user interface of a web application; a chat box associated with a chat application; a language processor; and a memory storing instructions that when executed by a processor perform operations comprising: receiving, from a user, a selection of an element presented in the user interface of the web application; receiving data associated with the selected element in the chat box associated with the chat application; receiving, from the user, a query corresponding to the selected element in the chat box; sending, to the language processor, a request for a list of application programming interfaces (APIs) that are relevant to the query and the data associated with the selected element; receiving, from the language processor, the list of relevant APIs; for each API on the list of relevant APIs: sending, to the API, the query and the data associated with the selected element; and receiving, from the API, an answer to the query including a data text and a data object; sending, to the language processor, a request for a cohesive answer for the user based on the data texts received from the APIs; receiving, from the language processor, the cohesive answer; determining whether the web application is capable of rendering the data object; and based at least on determining that the web application is capable of rendering the data object, presenting the data object and the cohesive answer on the user interface of the web application.

An example computerized method comprises receiving data associated with a selected element in a chat box associated with a chat application, wherein the selected element is selected by a user from a user interface of a web application; receiving, from the user, a query corresponding to the selected element in the chat box; sending, to a language processor, a request for a list of application programming interfaces (APIs) that are relevant to the query and the data associated with the selected element; receiving, from the language processor, the list of relevant APIs; for each API on the list of relevant APIs: sending, to the API, the query and the data associated with the selected element; and receiving, from the API, an answer to the query including a data text and a data object; sending, to the language processor, a request for a cohesive answer for the user based on the data texts received from the APIs; receiving, from the language processor, the cohesive answer; determining whether the web application is capable of rendering the data object; and based at least on determining that the web application is capable of rendering the data object, presenting the data object and the cohesive answer on the user interface of the web application.

An example computer storage medium storing computer-executable instructions that, when executed by a processor, cause the processor to perform operations comprising: receiving data associated with a selected element in a chat box associated with a chat application, wherein the selected element is selected by a user from a user interface of a web application; receiving, from the user, a query corresponding to the selected element in the chat box; sending, to a language processor, a request for a list of application programming interfaces (APIs) that are relevant to the query and the data associated with the selected element; receiving, from the language processor, the list of relevant APIs; for each API on the list of relevant APIs: sending, to the API, the query and the data associated with the selected element; and receiving, from the API, an answer to the query including a data text and a data object; sending, to the language processor, a request for a cohesive answer for the user based on the data texts received from the APIs; receiving, from the language processor, the cohesive answer; determining whether the web application is capable of rendering the data object; and based at least on determining that the web application is capable of rendering the data object, presenting the data object and the cohesive answer on the user interface of the web application.

Alternatively, or in addition to the other examples described herein, examples include any combination of the following:
wherein the data object is a document card, a chart, an image, or a video.
wherein the chat application is running in background, the method further comprising invoking the chat box associated with the chat application in response to a selection of the element presented in the user interface of the web application.
receiving, from the user, a second query corresponding to the data object; sending, to the language processor, a request for a list of APIs that are relevant to the second query and data associated with the data object; receiving, from the language processor, the list of relevant APIs; for each API on the list of relevant APIs: sending, to the API, the second query and the data associated with the data object; and receiving, from the API, an answer to the second query including a second data text and a second data object; sending, to the language processor, a request for a second cohesive answer for the user based on the second data texts received from the APIs; receiving, from the language processor, the second cohesive answer;
determining whether the web application is capable of rendering the second data object; and based at least on determining that the web application is capable of rendering the second data object presenting the second data object and the second cohesive answer to the user on the user interface of the web application.
wherein the user selects the element from a plurality of elements presented on the user interface via a mouse click, a touch input, a gesture input, an eye gaze, or a verbal command.
wherein the user interface comprises a visual portion and a text box portion, wherein the data object is presented in the visual portion and the cohesive answer is presented to the user in the text box portion.
wherein the data object comprises a visual representation corresponding to the cohesive answer.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving data associated with a selected element in a chat box associated with a chat application, wherein the selected element is selected by a user from a user interface of a web application; exemplary means for receiving, from the user, a query corresponding to the selected element in the chat box; exemplary means for sending, to a language processor, a request for a list of application programming interfaces (APIs) that are relevant to the query and the data associated with the selected element; exemplary means for receiving, from the language processor, the list of relevant APIs; for each API on the list of relevant APIs: exemplary means for sending, to the API, the query and the data associated with the selected element; and exemplary means for receiving, from the API, an answer to the query including a data text and a data object; exemplary means for sending, to the language processor, a request for a cohesive answer for the user based on the data texts received from the APIs; exemplary means for receiving, from the language processor, the cohesive answer; exemplary means for determining whether the web application is capable of rendering the data object; and based at least on determining that the web application is capable of rendering the data object, exemplary means for presenting the data object and the cohesive answer on the user interface of the web application.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving data associated with a selected element associated with a chat application, wherein the selected element is selected by a user from a user interface of a web application;
receiving, from the user, a query corresponding to the selected element;
sending, to a language processor, a request for a list of application programming interfaces (APIs) that are relevant to the query and the data associated with the selected element;
receiving, from the language processor, the list of relevant APIs;
for each API on the list of relevant APIs:
sending, to the API, the query and the data associated with the selected element; and
receiving, from the API, an answer to the query including a data text and a data object;
sending, to the language processor, a request for a cohesive answer for the user based on the data texts received from the APIs;
receiving, from the language processor, the cohesive answer;
determining whether the web application is capable of rendering the data object; and
based at least on determining that the web application is capable of rendering the data object, presenting the data object and the cohesive answer on the user interface of the web application.

2. The method of claim 1, wherein the data object is a document card, a chart, an image, or a video.

3. The method of claim 1, wherein the chat application is running in background, the method further comprising invoking a chat box associated with the chat application in response to a selection of the element presented in the user interface of the web application.

4. The method of claim 1, further comprising:
receiving, from the user, a second query corresponding to the data object;
sending, to the language processor, a request for a list of APIs that are relevant to the second query and data associated with the data object;
receiving, from the language processor, the list of relevant APIs;
for each API on the list of relevant APIs:
sending, to the API, the second query and the data associated with the data object; and
receiving, from the API, an answer to the second query including a second data text and a second data object;
sending, to the language processor, a request for a second cohesive answer for the user based on the second data texts received from the APIs;
receiving, from the language processor, the second cohesive answer;
determining whether the web application is capable of rendering the second data object; and
based at least on determining that the web application is capable of rendering the second data object presenting the second data object and the second cohesive answer to the user on the user interface of the web application.

5. The method of claim 1, wherein the user selects the element from a plurality of elements presented on the user interface via a mouse click, a touch input, a gesture input, an eye gaze, or a verbal command.

6. The method of claim 1, wherein the user interface comprises a visual portion and a text box portion, wherein the data object is presented in the visual portion and the cohesive answer is presented to the user in the text box portion.

7. The method of claim 1, wherein the data object comprises a visual representation corresponding to the cohesive answer.

8. A system comprising:
a user interface of a web application;
a chat box associated with a chat application;
a language processor; and
a memory storing instructions that when executed by a processor perform operations comprising:
receiving, from a user, a selection of an element presented in the user interface of the web application;
receiving data associated with the selected element in the chat box associated with the chat application;
receiving, from the user, a query corresponding to the selected element in the chat box;
sending, to the language processor, a request for a list of application programming interfaces (APIs) that are relevant to the query and the data associated with the selected element;
receiving, from the language processor, the list of relevant APIs;
for each API on the list of relevant APIs:
sending, to the API, the query and the data associated with the selected element; and
receiving, from the API, an answer to the query including a data text and a data object;
sending, to the language processor, a request for a cohesive answer for the user based on the data texts received from the APIs;
receiving, from the language processor, the cohesive answer;
determining whether the web application is capable of rendering the data object; and
based at least on determining that the web application is capable of rendering the data object, presenting the data object and the cohesive answer on the user interface of the web application.

9. The system of claim 8, wherein the data object is a document card, a chart, an image, or a video.

10. The system of claim 8, wherein the chat application is running in background, and wherein the memory further stores instructions that when executed by the processor invokes the chat box associated with the chat application in response to a selection of the element presented in the user interface of the web application.

11. The system of claim 8, the operations further comprising:
receiving, from the user, a second query corresponding to the data object;
sending, to the language processor, a request for a list of APIs that are relevant to the second query and data associated with the data object;
receiving, from the language processor, the list of relevant APIs;
for each API on the list of relevant APIs:
sending, to the API, the second query and the data associated with the data object; and
receiving, from the API, an answer to the second query including a second data text and a second data object;
sending, to the language processor, a request for a second cohesive answer for the user based on the second data texts received from the APIs;
receiving, from the language processor, the second cohesive answer;
determining whether the web application is capable of rendering the second data object; and
based at least on determining that the web application is capable of rendering the second data object presenting the second data object and the second cohesive answer to the user on the user interface of the web application.

12. The system of claim 8, wherein the user selects the element from a plurality of elements presented on the user interface via a mouse click, a touch input, a gesture input, an eye gaze, or a verbal command.

13. The system of claim 8, wherein the user interface comprises a visual portion and a text box portion, wherein the data object is presented in the visual portion and the cohesive answer is presented to the user in the text box portion.

14. The system of claim 8, wherein the data object comprises a visual representation corresponding to the cohesive answer.

15. A computer storage medium storing computer-executable instructions that, when executed by a processor, cause the processor to perform operations comprising:
receiving data associated with a selected element associated with a chat application, wherein the selected element is selected by a user from a user interface of a web application;
receiving, from the user, a query corresponding to the selected element;
sending, to a language processor, a request for a list of application programming interfaces (APIs) that are relevant to the query and the data associated with the selected element;
receiving, from the language processor, the list of relevant APIs;
for each API on the list of relevant APIs:
sending, to the API, the query and the data associated with the selected element; and
receiving, from the API, an answer to the query including a data text and a data object;
sending, to the language processor, a request for a cohesive answer for the user based on the data texts received from the APIs;
receiving, from the language processor, the cohesive answer;
determining whether the web application is capable of rendering the data object; and
based at least on determining that the web application is capable of rendering the data object, presenting the data object and the cohesive answer on the user interface of the web application.

16. The computer storage medium of claim 15, wherein the data object is a document card, a chart, an image, or a video.

17. The computer storage medium of claim 15, wherein the chat application is running in background, and wherein the computer-executable instructions further cause the processor to invoke the chat box associated with the chat application in response to a selection of the element presented in the user interface of the web application.

18. The computer storage medium of claim 15, the operations further comprising:
receiving, from the user, a second query corresponding to the data object;
sending, to the language processor, a request for a list of APIs that are relevant to the second query and data associated with the data object;
receiving, from the language processor, the list of relevant APIs;
for each API on the list of relevant APIs:
sending, to the API, the second query and the data associated with the data object; and
receiving, from the API, an answer to the second query including a second data text and a second data object;
sending, to the language processor, a request for a second cohesive answer for the user based on the second data texts received from the APIs;
receiving, from the language processor, the second cohesive answer;
determining whether the web application is capable of rendering the second data object; and
based at least on determining that the web application is capable of rendering the second data object presenting the second data object and the second cohesive answer to the user on the user interface of the web application.

19. The computer storage medium of claim 15, wherein the user selects the element from a plurality of elements presented on the user interface via a mouse click, a touch input, a gesture input, an eye gaze, or a verbal command.

20. The computer storage medium of claim 15, wherein the user interface comprises a visual portion and a text box portion, wherein the data object is presented in the visual portion and the cohesive answer is presented to the user in the text box portion.
